(19) United States
(12) Patent Application Publication
(10) Pub. No.: US 2008/0261590 A1
(43) Pub. Date: Oct. 23, 2008

(54) System and method for providing multimedia messaging service

(75) Inventor: Michael Man-Hak Tso, Tokyo (JP)

Correspondence Address: CROWELL & MORING LLP;INTELLECTUAL PROPERTY GROUP, P.O. BOX 14300, WASHINGTON, DC, 20044-4300, US

(73) Assignee: Gemini Mobile Technologies, Inc., San Mateo, CA (US)

(21) Appl. No.: 11/788,633

(22) Filed: Apr. 19, 2007

(51) Int. Cl. H04Q 7/20

(52) U.S. Cl. 455/432.2

(57) ABSTRACT

A mail message, sent by a subscriber of a Mobile Station Integrated Services Digital Network (MSISDN)-restricted messaging service, may be intercepted by a network gateway. A unique ID number, which may be in the form of a standard MSISDN number, may be assigned to the restricted subscriber, and used to send the mail message as a multimedia mail service (MMS) message to a recipient subscriber of an MSISDN-based messaging service. In one embodiment, the ID number may be used as the sender's MSISDN number. In another embodiment, the recipient may reply to the message without ever seeing the sender's actual MSISDN such that privacy is protected but communication is enabled.

### FIELD OF THE INVENTION

The present invention relates generally to messaging services, and more particularly to providing multimedia messaging service to subscribers whose phone numbers are automatically hidden by their network provider during messaging operations.

### BACKGROUND OF THE INVENTION

Most telecommunication carriers provide various messaging services to their subscribers. For example, so-called text messaging is a very common messaging service based on the Short Message Service (SMS) protocol. In addition, Multimedia Messaging Service (MMS) is a standard for sending telephony messages that include multimedia objects (e.g., images, audio, video, rich text, etc.) and not just text, as is the case with SMS messages. MMS addressing, however, is often times based on the MM4/MM5 protocol, which relies on subscriber telephone numbers for proper message routing. Mobile telephone numbers are referred to generally as Mobile Station Integrated Services Digital Network (MSISDN) numbers, and each mobile subscriber is assigned a unique MSISDN number. A standard MSISDN number is a fixed number of digits (may be 10 or 15-digit, depending on service provider) number that is used to route calls and data to a particular mobile device.

However, certain telecommunication carriers have messaging services that implement security policies against displaying subscriber MSISDN numbers during messaging operations for mail messages leaving the network. While such telecommunication carriers may allow subscribers of their messaging services to exchange messages with each other using MSISDNs, where both “to” and “from” addresses are MSISDNs, mail messages destined for other carriers' users require an email address to be used to replace the “from” and “reply-to” address of the original sender. Thus, such services are MSISDN-restricted messaging services in that they have a policy of not displaying subscriber MSISDN numbers to non-subscribers. In fact, users of the same telecommunication carrier may be treated differently, depending on which messaging service they subscribe to (e.g., MSISDN-restricted or non-MSISDN-restricted).

The result is that MSISDN-restricted messaging services inhibit their subscribers from engaging in both inter-carrier MMS messaging, both domestically as well as internationally. This is due to the fact that such services use the subscribers' email addresses for routing mail messages instead of the subscribers' MSISDN numbers. However, currently most overseas mobile carriers do not accept incoming email-based messages (e.g., Simple Mail Transfer Protocol (SMTP) messages). Instead, most cellular carriers process mail in the form of Multimedia Messaging Service (MMS) messages, in accordance with the MM4/MM5 protocol which requires the subscribers' MSISDN number. Thus, inter-carrier MMS connectivity is not currently possible with subscribers of MSISDN-restricted messaging services. This is inconvenient since there are two addresses to remember for each subscriber—a phone number for phone calls and an email address for messaging. Email-based messaging is difficult to charge for (since mail from another carrier is difficult to distinguish from mail from the internet), and also inhibits the use of Mobile-Number-Portability (MNP) policies, in which a user can move from one carrier to another while maintain the same phone number. In contrast, when moving from one carrier to another, users cannot keep their email address, as email addresses are carrier-domain specific.

Moreover, email-based messaging can also be less secure than telephony-based messaging since the messages are sent over the Internet—an open, public network. As such, there is a need for a system and method of providing standards-based messaging (e.g., MMS messaging) with subscribers of MSISDN-restricted messaging services.

### SUMMARY OF THE INVENTION

Disclosed and claimed herein is a method, gateway and computer program product for inter-carrier messaging services. In one embodiment, a method includes intercepting a mail message formatted in accordance with a first protocol and sent by a first subscriber using a Mobile Station Integrated Services Digital Network (MSISDN)-restricted messaging service, determining an MSISDN number for the first subscriber, and converting the mail message from the first protocol to a second protocol recognized by an MSISDN-based messaging service of a second subscriber. The method further includes sending the mail message to the second subscriber using the first subscriber's MSISDN number in accordance with the second protocol.

In another embodiment, a network gateway includes a first network interface configured to intercept a mail message formatted in accordance with a first protocol and sent by a first subscriber using a Mobile Station Integrated Services Digital Network (MSISDN)-restricted messaging service, and a second network interface for communicating with an MSISDN-based messaging service of a second subscriber. The network gateway further includes a protocol conversion module configured to determine an MSISDN number for the first subscriber, convert the mail message from the first protocol to a second protocol recognized by the MSISDN-based messaging service of the second subscriber, and send the mail message to the second subscriber, via the second network interface, and using the first subscriber's MSISDN number in accordance with the second protocol.

Other aspects, features, and techniques of the invention will be apparent to one skilled in the relevant art in view of the following description of the exemplary embodiments of the invention.

### BRIEF DESCRIPTION OF THE DRAWINGS

FIGS. 1A-1B illustrate messaging systems in accordance with embodiments of the invention;

FIG. 2 is a process for implementing one embodiment of the invention; and

FIG. 3 is a process for implementing another embodiment of the invention.

### DETAILED DESCRIPTION OF THE EXEMPLARY EMBODIMENTS

One aspect of the invention is to enable subscribers of a MSISDN-restricted messaging service to engage in inter-carrier mail messaging, such as MMS messaging. As used herein, the term “MSISDN-restricted” refers to a network or service which has implemented security policies against displaying or using its users' MSISDN numbers during messaging operations, including mail messaging. To that end, in one embodiment subscribers of an MSISDN-restricted messaging service may be provided with the ability to send/receive mail messages, including MMS messages, with subscribers of MSISDN-based messaging services. Such subscribers are generally referred to herein as “MSISDN-restricted messaging service subscribers,” “MSISDN-restricted subscribers” or simply as “restricted subscribers.”

Another aspect of the invention is to enable send/receive operations for mail messages between restricted subscribers and non-restricted subscribers, whether or not they both belong to the same network.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means any of the following: A; B; C; A and B; A and C; B and C; A, B and C. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium, which may include any medium that can store or transfer information. Examples of processor readable mediums include an electronic circuit, a semiconductor memory device, a read-only memory (ROM), a flash memory or other non-volatile memory, a floppy diskette, a CD-ROM, an optical disk, a hard disk, a fiber optic medium, a radio frequency (RF) link, etc.

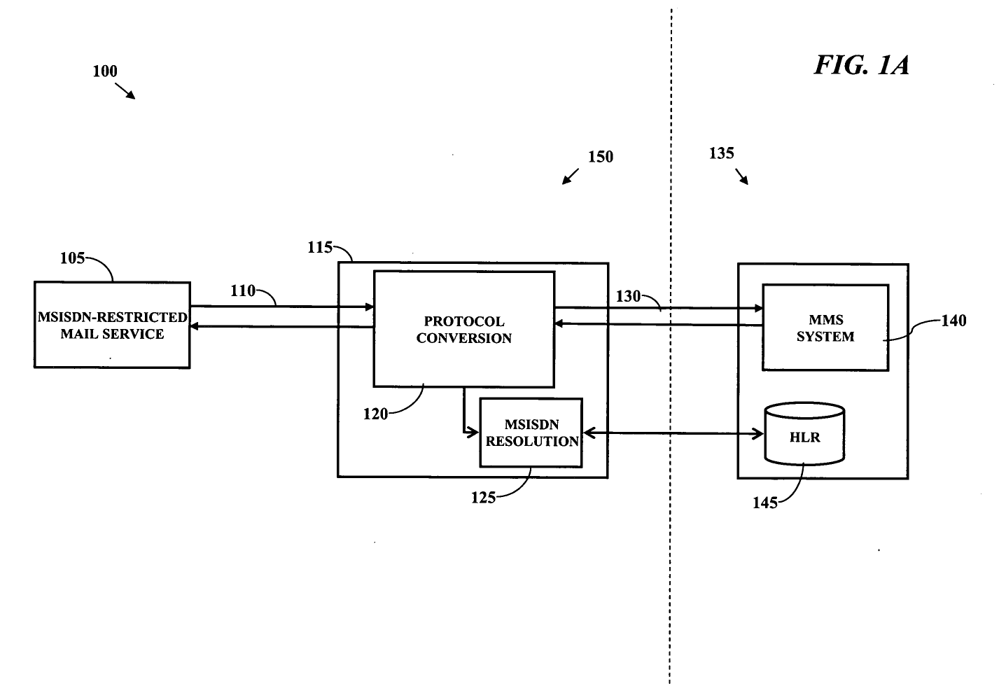

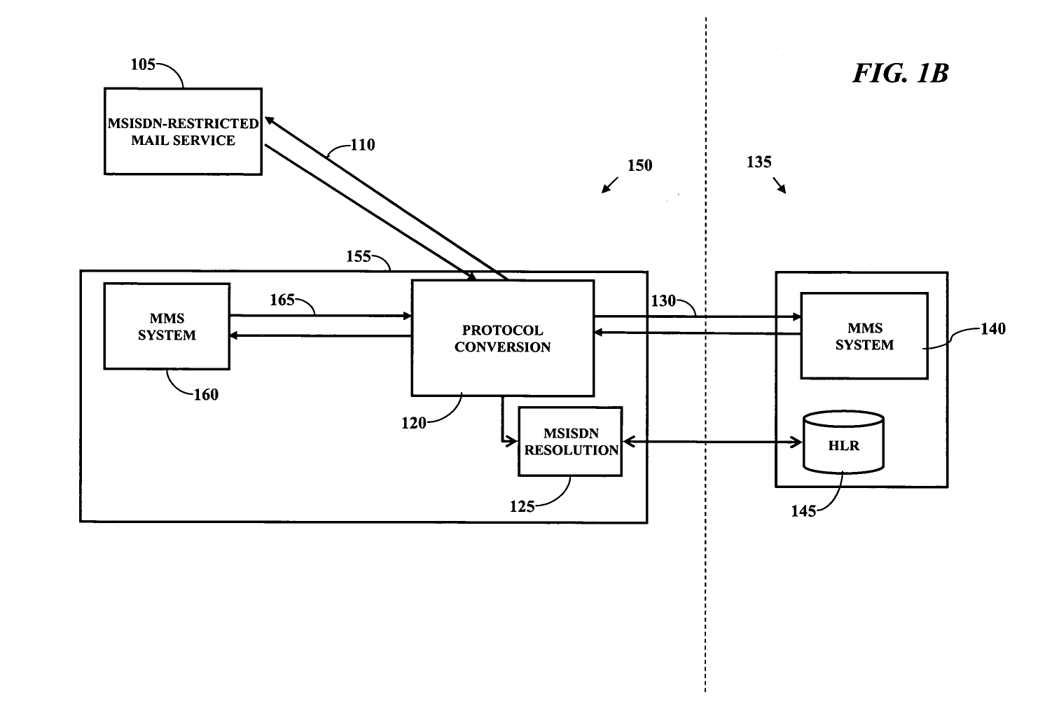

Referring now to FIG. 1A, depicted is one embodiment of a mail messaging system 100 for carrying out one or more embodiments of the invention. As shown, the mail messaging system 100 is comprised of carrier networks 135 and 150. It should be appreciated that the mail messaging system 100 of FIG. 1A may be an inter-carrier messaging system in which, for example, carrier network 135 is located overseas from carrier network 150. However, in other embodiments carrier networks 135 and 150 need not necessarily be located overseas from one another.

Carrier network 150 includes an MSISDN-restricted mail service 105. In one embodiment, the MSISDN-restricted mail service 105 implements a policy which automatically hides its subscribers' MSISDN numbers from non-subscribers during mail messaging operations. The MSISDN-restricted mail service 105 is depicted as communicating with network gateway 115 with which mail messages 110 may be exchanged. In one embodiment, mail messages 110 may include both MSISDN-based mail messages and SMTP (email addressed) mail messages. In the case of MSISDN-based mail messages, such messages may include MMS messages which are routed based on the sender/receiver MSISDN numbers, and in accordance with the MM4/MM5 protocol (or any other MSISDN-based protocol). In the case of SMTP-based mail messages, such messages may include mail messages (e.g., email messages) which are routed based on the sender/receiver SMTP addresses while hiding the sending subscriber's MSISDN number, in accordance with the policies of an MSISDN-restricted messaging service.

Network gateway 115, which is also in communication with carrier network 135, includes a protocol conversion module 120 and an MSISDN resolution module 125. In one embodiment, and as will be described in more detail below, the protocol conversion module 120 may be configured to convert SMTP-based mail messages to MSISDN-based messages, and vice versa. MSISDN resolution module 125 may be configured to communicate with a Home Location Register (HLR) 145 of the carrier network 135 and/or an HLR of carrier network 150 (not shown). In one embodiment, MSISDN resolution module 125 communicates with the HLR 145 in order to obtain MSISDN information for message routing to subscribers of carrier network 135.

Continuing to refer to FIG. 1A, carrier network 135 further includes an MMS system 140 configured to process incoming and outgoing MMS messages 130 being exchanged with subscribers of MSISDN-restricted mail service 105. In one embodiment, such MMS messages are processed in accordance with the MM4/MM5 protocol using subscriber MSISDN information. In another embodiment, the MMS system 140 comprises a Multimedia Messaging Service Center (MMSC), the use of which enables subscribers of carrier network 135 (or more precisely the subscribers of MMS system 140) to exchange MMS messages amongst each other, as well as with subscribers of the MSISDN-restricted mail service 105.

Referring now to FIG. 1B, depicted is another embodiment of the mail messaging system 100 of FIG. 1A. As shown, carrier network 150 includes the previously-described MSISDN-restricted mail service 105, as well as a network gateway 155. However, unlike the network gateway 115 of FIG. 1A, network gateway 155 further includes an MMS system 160. In this fashion, carrier network 150 may provide full MMS messaging functionality to its subscribers. That is, the MMS system 160 may serve an equivalent function as the previously-described MMS system 140 (e.g., MMSC), except that it is used to serve the unrestricted subscribers of carrier network 150. It should further be appreciated that the MMS system 160 may be configured as any other messaging system which is not MSISDN restricted.

Subscribers of the previously-described MSISDN-restricted mail service 105 may also wish to exchange MSISDN-based messages with subscribers of the MMS system 160 in the same fashion as the invention enables with the subscribers of MMS system 140. To that end, protocol conversion module 120 may be further configured to process MMS messages 160 in the same manner as described above with reference to MMS messages 130. In particular, a mail message 110 intended for a subscriber of the carrier network 150 may be processed by the protocol conversion module 120, as described above. However, once the mail message 110 has been converted to an MSISDN-based message, it may be provided to the MMS system 160 as an MMS message 165 (e.g., MM4/MM5 protocol message).

Thus, exchanges of mail messages are facilitated by the interception and conversion of messages between MSISDN-restricted subscribers (e.g., subscribers of the MSISDN-restricted mail service 105) and MMS-based messaging service subscribers (e.g., subscribers of MMS systems 140 and 160).

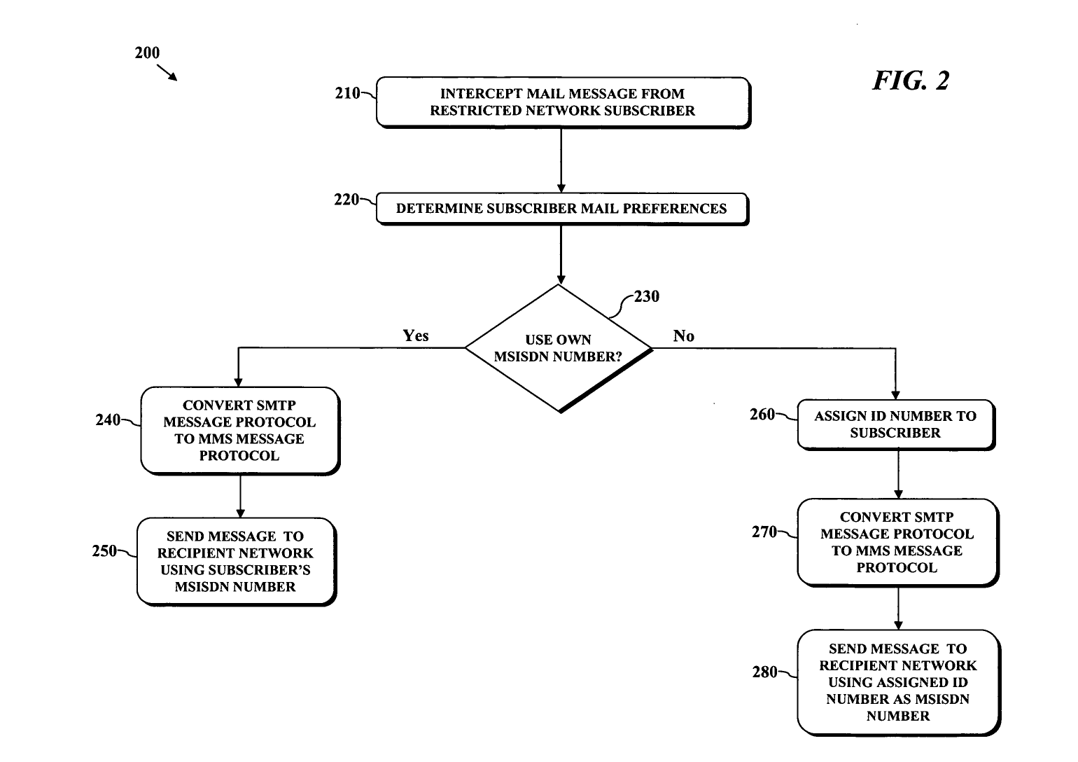

Referring now to FIG. 2, depicted is one embodiment for processing a mail message sent by a subscriber of an MSISDN-restricted messaging service (e.g., MSISDN-restricted mail service 105 of FIGS. 1A-1B), which is intended for a non- MSISDN-restricted service recipient (e.g., MMS system 140 of FIGS. 1A-1B or MMS system 160 of FIG. 1B). While process 200 is described in terms of MMS messaging, it should be appreciated that it may be equally applicable to any other messaging protocol. In certain embodiments, process 200 may be performed by a network gateway for an MSISDN-restricted messaging service or network (e.g., network gateway 115 of FIG. 1A or network gateway 155 of FIG. 1B), wherein the gateway performs a protocol conversion operation.

Process 200 begins at block 210 with the interception of a mail message (e.g., mail message 110 of FIGS. 1A-1B) originating from an MSISDN-restricted subscriber, and intended for a non-MSISDN-restricted recipient. Since the originating subscriber is an MSISDN-restricted subscriber, the mail message may be sent using the subscriber's email address in accordance with the SMTP protocol, for example. In one embodiment, the interception operation of block 210 may be triggered upon process 200 detecting a message with an un-resolvable or other carriers' address (e.g., by network gateway 115 of FIG. 1A or network gateway 155 of FIG. 1B). In one embodiment, the intercepted message may be not undergo any address or format conversion by process 200 prior to being forward to block 210.

In another embodiment, the interception operation of block 210 may again be triggered upon the process 200 detecting a message with an un-resolvable or other carriers' address, but the message may instead be address and format-translated by process 200 as it normally would for non-restricted subscribers prior to being forwarded to block 210.

In still another embodiment, the interception operation of block 210 may be handled by a SMTP (or other protocol) gateway or proxy, which forwards the message to block 210.

Regardless of the method or circumstance under which the message is interrupted, once the mail message is received at block 210 process 200 continues to block 220 where a determination is made as to the restricted subscriber's mail preference. In one embodiment, the operation of block 220 may be performed by redirecting the restricted subscriber to an online graphical user interface for providing the subscriber preference. To that end, in one embodiment a message may be sent back to the restricted subscriber containing instructions and a uniform resource locator (URL) to a configuration web page, or the like.

It should further be appreciated that the operation of block 220 may be performed only once when the restricted subscriber first attempts to send a mail message to a non-restricted subscriber. Alternatively, the operation of block 220 may be performed only once for each individual recipient, or alternatively every time the restricted subscriber attempts to send a mail message to a non-restricted subscriber.

In any event, the restricted subscriber's mail preference may include an indication not to use the subscriber's actual MSISDN number for message routing, thereby keeping the MSISDN number hidden from the recipient, or alternatively to use MSISDN number for routing the message to the intended recipient. To that end, decision block 230 determines if the subscriber's actual MSISDN number is to be used or not. If the subscriber elects to use their actual MSISDN number, process 200 may continue to block 240 where the mail message may first be converted from an SMTP protocol to a MMS message protocol such that it will be recognized and properly processed by the recipient's messaging service (e.g., using protocol conversion module 120 of FIGS. 1A-1B). The conversion operation of block 240 may further include a lookup operation whereby the subscriber's email address is used to lookup the subscriber's MSISDN number. In any event, once converted, the mail message may be sent using the subscriber's MSISDN number at block 250 as an MMS message (e.g., MMS message 130 of FIGS. 1A-1B or MMS message 165 of FIG. 1B), and in one embodiment in accordance with the MM4/MM5 protocol. As such, the non-MSISDN restricted recipient's MMSC (e.g., MMS system 140 of FIGS. 1A-1B or MMS system 160 of FIG. 1B) will be able to recognize and process the mail message as a standard MMS message.

If, on the other hand, the restricted subscriber desires not to use their actual MSISDN number and keep it hidden from the recipient, process 200 will continue to block 260 where an ID number will be assigned to the restricted subscriber. In one embodiment, this ID number may be a temporary value, and may be in the form of a temporarily-assigned MSISDN number. It should be appreciated that the period of time which this temporary ID number is assigned to the restricted subscriber may vary from as short as a one-time use to as long as one day, one month, one year, etc. Alternatively, the ID number assigned at block 260 may be indefinitely assigned to the particular restricted subscriber, such that no predetermined time of expiration is set until the subscriber cancels his primary MSISDN (e.g. canceling his service plan). Furthermore, the carrier may charge differently based on the amount of time that the particular MSISDN is to be assigned (e.g. daily fee, monthly fee, one-time fee, etc.). It may be preferable for the assigned ID to be a valid MSISDN for SS7/HLR network routing purposes, so that a reply message from the recipient can be properly routed back to the sender's network. For countries without MNP policies, the assigned ID may need to have particular leading digits indicative of the country and carrier, and it may also ne limited to a maximum length. In countries with MNP policies, the assigned ID may be a fully valid MSISDN registered in the MNP database (typically accessed via HLRs). The MNP database may translate MSISDNs to their respective carriers. Registering valid MSISDNs with the MNP database and/or the subscriber's HLR may be performed as part of step 260, or it may be done singularly or in batch before step 200.

For certain carriers, the number of MSISDNs in use at any one time may be limited by regulation or some other factor. For such carriers, generating a new MSISDN for each subscriber may be unduly burdensome. As such, in certain embodiments the assigned ID may be longer than standard MSISDNs used in that carrier's country. Since standard MSISDNs are typically shorter than the maximum allowable length set by the applicable standard (which can be upwards of 20 digits), using slightly longer MSISDNs for newly assigned IDs will enable carriers with limited MSISDN allocations to fully implement the invention without impinging on their stock of standard-length MSISDNs.

In certain embodiments, the assigning operation of block 260 may further comprise saving the assigned ID number (e.g., assigned MSISDN number), along with the restricted subscriber's real MSISDN number and/or the restricted subscriber's email address in a database, such as a Lightweight Directory Access Protocol (LDAP) database. In one embodiment, the database may further include such information as ID number expiration date, storage/deletion policies for mail messages, billing information, user preference data, etc. In certain embodiments, the operation of block 260 may be performed by a network gateway module, such as protocol conversion module 120 of FIG. 1A.

Continuing to refer to FIG. 2, process 200 may then continue to block 270 where the mail message may first be converted from an SMTP protocol to a MMS message protocol such that it will be recognized and processed by the recipient's messaging service (e.g., using protocol conversion module 120 of FIGS. 1A-1B). Thereafter, at block 280 the mail message may be sent to the intended recipient as an MMS message (e.g., MMS message 130 of FIGS. 1A-1B or MMS message 166 of FIG. 1B), using the assigned ID number as the MSISDN number for the otherwise restricted subscriber. That is, the assigned ID number may be used to populate the “From” and “Reply To” fields of the mail message, as would be expected and recognized by the recipient's MMSC (e.g., MMS system 140 of FIGS. 1A-1B or MMS system 160 of FIG. 1B). While the ID number of process 200 has been described in terms of an MSISDN number, it should be understood that the ID number may be any value capable of uniquely identifying a user for purposes of sending/receiving inter-carrier mail messages, such as MMS messages.

In certain embodiments, process 200 may further include the appending of a notice to the outgoing message relating to the fact that the displayed reply address is not the sender's actual MSISDN. This may alleviate confusion when the recipient of the message of process 200 attempts, for example, to call the restricted subscriber back, or when the “From” field shows a number that doesn't otherwise match the contact information the recipient has for the restricted subscriber.

In this fashion, an MSISDN-restricted messaging service subscriber may send MMS messages, international or otherwise, without ever having to divulge their true MSISDN numbers.

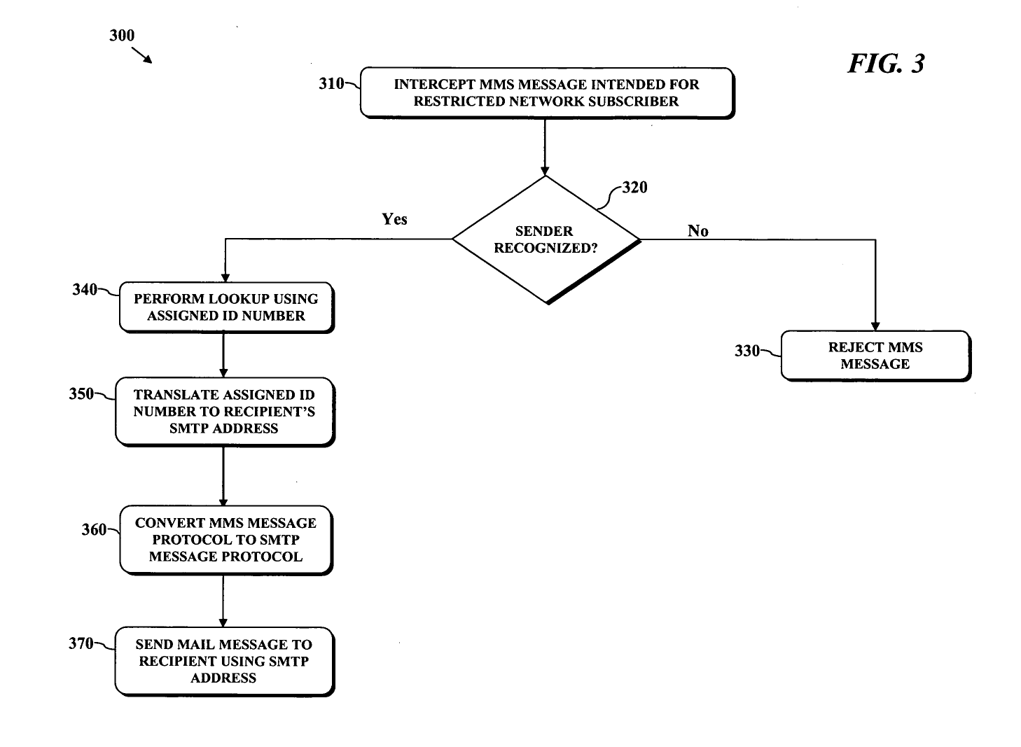

Referring now to FIG. 3, depicted is one embodiment for processing an MMS message sent to an MSISDN-restricted messaging service subscriber using an assigned ID number (e.g., assigned ID number from block 260 of FIG. 2). As with process 200 above, process 300 may be performed by a network gateway for the MSISDN-restricted network, wherein the gateway supports both MMS (e.g., MM4/MM5) and SMTP (e.g., network gateway 115 of FIG. 1A or network gateway 155 of FIG. 1B).

Process 300 begins at block 310 where the MMS message (e.g., MMS message 130 of FIGS. 1A-1B or MMS message 165 of FIG. 1B) intended for the MSISDN-restricted subscriber is intercepted (e.g., by network gateway 115 of FIG. 1A or network gateway 155 of FIG. 1B). It should be appreciated that invalid communications directed to an assigned ID may be inadvertently made. For example, a voice or fax attempt may be inadvertently directed to a particular assigned ID. In such cases, the carrier may supply a pre-recorded voice or data message for such callers, accompanied by an explanation regarding the limited messaging use for the called MSISDN. Alternatively, a valid MSISDN associated with the called party may be played for the calling party.

Once a valid MMS message is received at block 310, process 300 continues to block 320 where a determination is made as to whether the sender is recognized or not. In one embodiment, the sender may be recognized by virtue of the fact that the sender has previously received a message from the intended recipient, and therefore would validly have the intended recipient's assigned ID number. If it is determined that the sender is not recognized, process 300 may continue to block 330 where the MMS message may be rejected. However, in another embodiment the MMS message may be processed despite the fact that the sender may not be recognized.

In another embodiment, a sender may be recognized by virtue of being listed on a so-called “whitelist” of allowed senders' phone numbers. In one embodiment, the whitelist may be manually edited by the MSISDN-restricted messaging service subscriber (e.g., using a web interface). Alternatively, or in addition thereto, the whitelist may be automatically appended with the phone numbers to which the restricted subscriber sends messages. In another embodiment, phone numbers on whitelist may automatically expire after some period of inactivity, for example.

If, on the other hand, it is determined that the sender is recognized (e.g., on the whitelist) at block 320, then process 300 may continue to block 340 where a lookup of the assigned ID number may be performed. In one embodiment, the operation of block 340 may comprise using a database (e.g., LDAP database) of the network gateway, as described above with reference to FIG. 2. Regardless, in one embodiment the lookup operation of block 340 may result in the determination of the MSISDN-restricted subscriber's SMTP address. Once the MSISDN-restricted subscriber's information is located and identified, process 300 may continue to block 350 where the assigned ID number may be translated to the recipient's SMTP address.

While process 300 is directed to the situation where an MMS message has been sent to an MSISDN-restricted messaging service subscriber using an assigned ID number, in other embodiments the MSISDN-restricted messaging service subscriber may have chosen to use their own MSISDN instead of an assigned ID (see block 230 of FIG. 2). In that case, the operations of block 340 and 350 may be skipped since there would be no need to lookup and translate the subscriber's actual MSISDN.

Regardless of whether the subscriber's actual MSISDN or assigned ID was used to send the MMS message, the message is converted (e.g., using protocol conversion module 120 of FIGS. 1A-1B) from an MMS protocol to a SMTP protocol at block 360 such that it will be recognized by the MSISDN-restricted messaging service (e.g., MSISDN-restricted mail service 105 of FIGS. 1A-1B). Thereafter, the mail message may be delivered to the MSISDN-restricted subscriber using the subscriber's standard email address at block 370.

In this fashion, an MSISDN-restricted subscriber may receive MMS messages, international or otherwise, without ever having to divulge their true MSISDN numbers.

While the invention has been described in connection with various embodiments, it should be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for mail messaging comprising the acts of:
intercepting a mail message formatted in accordance with a first protocol and sent by a first subscriber using a Mobile Station Integrated Services Digital Network (MSISDN)-restricted messaging service;
determining an MSISDN number for the first subscriber;
converting the mail message from the first protocol to a second protocol recognized by an MSISDN-based messaging service of a second subscriber; and
sending the mail message to the second subscriber using the first subscriber's MSISDN number in accordance with the second protocol.

2. The method of claim 1, wherein the MSISDN number is a number selected from the list consisting of: an actual MSISDN number for the first subscriber, a temporarily-assigned ID number, and an indefinitely assigned ID number.

3. The method of claim 2, wherein determining the MSISDN number further comprises determining a subscriber preference for using the actual MSISDN number for the first subscriber, the temporarily-assigned ID number, or the indefinitely assigned ID number.

4. The method of claim 2, wherein determining the MSISDN number comprises assigning the temporarily-assigned ID number as the MSISDN number to the first subscriber for a limited period of time.

5. The method of claim 1, wherein the mail message comprises a Simple Mail Transfer Protocol (SMTP) message sent using an SMTP address for the first subscriber.

6. The method of claim 5, further comprising associating the MSISDN number with the SMTP address of the first subscriber.

7. The method of claim 1, wherein the first protocol comprises Simple Mail Transfer Protocol (SMTP).

8. The method of claim 7, wherein the second protocol comprises a multimedia messaging service (MMS) protocol.

9. The method of claim 1, further comprising the acts of:
intercepting an incoming mail message formatted in accordance with the second protocol intended for the first subscriber;
determining if a sender of said incoming mail message is authorized; and
converting the mail message from the second protocol to the first protocol if the incoming mail message is from the authorized sender; and
sending the mail message to the first subscriber in accordance with the first protocol.

10. The method of claim 9, wherein the incoming mail message is addressed using an assigned ID of the first subscriber.

11. The method of claim 10, further comprising translating the assigned ID to an email address of the first subscriber.

12. The method of claim 9, further comprising rejecting the incoming mail message when the sender is not authorized.

13. A network gateway comprising:
a first network interface configured to intercept a mail message formatted in accordance with a first protocol and sent by a first subscriber using a Mobile Station Integrated Services Digital Network (MSISDN)-restricted messaging service;
a second network interface for communicating with an MSISDN-based messaging service of a second subscriber; and
a protocol conversion module configured to:
determine an MSISDN number for the first subscriber,
convert the mail message from the first protocol to a second protocol recognized by the MSISDN-based messaging service of the second subscriber, and
send the mail message to the second subscriber, using the second network interface, and using the first subscriber's MSISDN number in accordance with the second protocol.

14. The network gateway of claim 13, wherein the MSISDN number is a number selected from the list consisting of: an actual MSISDN number for the first subscriber, a temporarily-assigned ID number, and an indefinitely assigned ID number.

15. The network gateway of claim 14, wherein the protocol conversion module is further configured to determine a subscriber preference for using the actual MSISDN number for the first subscriber, the temporarily-assigned ID number, or the indefinitely assigned ID number.

16. The network gateway of claim 14, wherein the protocol conversion module is configured to determine the MSISDN number by assigning the temporarily-assigned ID number as the MSISDN number to the first subscriber for a limited period of time.

17. The network gateway of claim 13, wherein the mail message comprises a Simple Mail Transfer Protocol (SMTP) message sent using an SMTP address for the first subscriber.

18. The network gateway of claim 17, wherein the protocol conversion module is further configured to associate the MSISDN number with the SMTP address of the first subscriber.

19. The network gateway of claim 13, wherein the first protocol comprises Simple Mail Transfer Protocol (SMTP).

20. The network gateway of claim 19, wherein the second protocol comprises a multimedia messaging service (MMS) protocol.

21. The network gateway of claim 13, wherein the first network interface and second network interface are integrated into a single network interface.

22. The network gateway of claim 13, wherein the protocol conversion module is further configured to:
intercept an incoming mail message formatted in accordance with the second protocol intended for the first subscriber;
determine if a sender of said incoming mail message is authorized; and
convert the mail message from the second protocol to the first protocol if the incoming mail message is from the authorized sender; and
send the mail message to the first subscriber in accordance with the first protocol.

23. The network gateway of claim 22, wherein the incoming mail message is addressed using an assigned ID of the first subscriber.

24. The network gateway of claim 23, wherein the protocol conversion module is further configured to translate the assigned ID to an email address of the first subscriber.

25. The network gateway of claim 22, wherein the protocol conversion module is further configured to reject the incoming mail message when the sender is not authorized.

26. A computer program product comprising:
a processor readable medium having processor executable program code embodied therein for mail messaging, the processor executable program code including:
processor executable program code to intercept a mail message formatted in accordance with a first protocol and sent by a first subscriber using a Mobile Station Integrated Services Digital Network (MSISDN)-restricted messaging service;
processor executable program code to determine an MSISDN number for the first subscriber;
processor executable program code to convert the mail message from the first protocol to a second protocol recognized by an MSISDN-based messaging service of a second subscriber; and
processor executable program code to send the mail message to the second subscriber using the first subscriber's MSISDN number in accordance with the second protocol.

27. The computer program product of claim 26, wherein the MSISDN number is a number selected from the list consisting of: an actual MSISDN number for the first subscriber, a temporarily-assigned ID number, and an indefinitely assigned ID number.

28. The computer program product of claim 27, wherein the processor executable program code to determine the MSISDN number further comprises processor executable program code to determine a subscriber preference for using the actual MSISDN number for the first subscriber, the temporarily-assigned ID number, or the indefinitely assigned ID number.

29. The computer program product of claim 27, wherein the processor executable program code to determine the MSISDN number further comprises processor executable program code to assign the temporarily-assigned ID number as the MSISDN number to the first subscriber for a limited period of time.

30. The computer program product of claim 26, wherein the mail message comprises a Simple Mail Transfer Protocol (SMTP) message sent using an SMTP address for the first subscriber.

31. The computer program product of claim 30, wherein the processor readable medium further includes processor executable program code to associate the MSISDN number with the SMTP address of the first subscriber.

32. The computer program product of claim 26, wherein the first protocol comprises Simple Mail Transfer Protocol (SMTP).

33. The computer program product of claim 32, wherein the second protocol comprises a multimedia messaging service (MMS) protocol.

34. The computer program product of claim 26, wherein the processor readable medium further includes:
processor executable program code to intercept an incoming mail message formatted in accordance with the second protocol intended for the first subscriber;
processor executable program code to determine if a sender of said incoming mail message is authorized; and
processor executable program code to convert the mail message from the second protocol to the first protocol if the incoming mail message is from the authorized sender; and
processor executable program code to send the mail message to the first subscriber in accordance with the first protocol.

35. The computer program product of claim 34, wherein the incoming mail message is addressed using an assigned ID of the first subscriber.

36. The computer program product of claim 35, wherein the processor readable medium further includes processor executable program code to translate the assigned ID to an email address of the first subscriber.

37. The computer program product of claim 34, wherein the processor readable medium further includes processor executable program code to reject the incoming mail message when the sender is not authorized.
